(19) United States
(12) Patent Application Publication
(10) Pub. No.: US 2025/0133518 A1
(43) Pub. Date: Apr. 24, 2025

(54) METHOD, SYSTEM AND APPARATUS OF ENFORCING TIME SYNCHRONIZATION

(71) Applicant: ZTE Corporation, Shenzhen (CN)

(72) Inventors: Zhendong Li, Shenzhen (CN); Jinguo Zhu, Shenzhen (CN)

(73) Assignee: ZTE Corporation, Shenzhen (CN)

(21) Appl. No.: 18/990,743

(22) Filed: Dec. 20, 2024

Related U.S. Application Data
(63) Continuation of application No. PCT/CN2022/111218, filed on Aug. 9, 2022.

(51) Int. Cl. H04W 56/00; H04W 64/00

(52) U.S. Cl. CPC H04W 56/0015; H04W 56/006; H04W 64/00

(57) ABSTRACT

A wireless communication method for use in an access and mobility management function includes receiving, from a network function, time synchronization subscription information associated with a time synchronization service for a wireless terminal, and transmitting, to a wireless network node, a location subscription request for the wireless terminal.

### CROSS-REFERENCE TO RELATED APPLICATION

This application is a Continuation of PCT/CN2022/111218, filed on Aug. 9, 2022, titled “METHOD, SYSTEM AND APPARATUS OF ENFORCING TIME SYNCHRONIZATION”, and published as WO 2024/031352 A1 on Feb. 15, 2024, the entirety of which is incorporated herein by reference.

### TECHNICAL FIELD

This document is directed generally to wireless communications, and in particular to a time synchronization for wireless communications.

The existing 5G system supports time synchronization services to a UE (user equipment) via radio interface (i.e., air interface). For example, an NG-RAN (next generation radio access network (node)) may provide precise time information to the UE via a 5G AS (access stratum) signaling, which is called 5G access stratum time distribution. The UE may subscribe the time synchronization service in a particular area. Note that the UE may be restricted to obtain the time synchronization service solely in this particular area. When the UE moves out of the time synchronization service area, the time synchronization service may not be stopped for the UE.

This document relates to methods, systems, and devices for enforcing the time synchronization.

### SUMMARY

The present disclosure relates to a wireless communication method for use in an access and mobility management function. The method comprises:
receiving, from a network function, time synchronization subscription information associated with a time synchronization service for a wireless terminal, and
transmitting, to a wireless network node, a location subscription request for the wireless terminal.

Various embodiments may preferably implement the following features:

Preferably, the time synchronization subscription information comprises at least one of:
a time synchronization indication associated with a time synchronization subscription of the wireless terminal, or
a time synchronization service area associated with providing the time synchronization service to the wireless terminal.

Preferably, the location subscription request is for subscribing to a notification associated with the wireless terminal being in or out of a time synchronization area or a notification associated with a location of the wireless terminal.

Preferably, the wireless communication method further comprises:
receiving, from the wireless network node, a notification in response to the location subscription request,
transmitting, to the wireless network node, a request associated with providing the time synchronization service to the wireless terminal.

Preferably, the wireless terminal is in a time synchronization area based on the notification and the request indicates initiating providing the time synchronization service to the wireless terminal.

Preferably, the wireless terminal is out of a time synchronization area based on the notification, and the request indicates stopping providing the time synchronization service to the wireless terminal.

Preferably, the wireless communication method further comprises transmitting, to the wireless terminal, the time synchronization subscription information.

Preferably, the wireless communication method further comprises receiving, from the wireless terminal, a request associated with the time synchronization subscription information.

Preferably, the network function comprises at least one of a unified data management or a policy control function.

The present disclosure relates to a wireless communication method for use in a network function. The method comprises transmitting, to a wireless device, time synchronization subscription information associated with a time synchronization service for a wireless terminal.

Various embodiments may preferably implement the following features:

Preferably, the time synchronization subscription information comprises at least one of:
a time synchronization indication associated with a time synchronization subscription of the wireless terminal, or
a time synchronization service area associated with providing a time synchronization service to the wireless terminal.

Preferably, the network function comprises at least one of a unified data management or a policy control function.

Preferably, the wireless device is the wireless terminal or an access and mobility management function.

The present disclosure relates to a wireless communication for use in a wireless terminal. The method comprises receiving, from a wireless device, time synchronization subscription information associated with a time synchronization service for the wireless terminal.

Various embodiments may preferably implement the following features:

Preferably, the time synchronization subscription information comprises at least one of:
a time synchronization indication associated with a time synchronization subscription of the wireless terminal, or
a time synchronization service area associated with providing a time synchronization service to the wireless terminal.

Preferably, the wireless device comprises an access and mobility management function.

Preferably, the wireless communication method further comprises transmitting, to the wireless device, a request associated with the time synchronization subscription information.

Preferably, the wireless device comprises at least one of a unified data management or a policy control function.

Preferably, the wireless terminal receives the time synchronization subscription information from the wireless device via an access and mobility management function.

The present disclosure relates to an access and mobility management node, comprising:
a communication unit, configured to: receive, from a network function, time synchronization subscription information associated with a time synchronization service for a wireless terminal, and transmit, to a wireless network node, a location subscription request for the wireless terminal.

Various embodiments may preferably implement the following feature:

Preferably, the access and mobility management node further comprises a processor configured to perform any of aforementioned wireless communication methods.

The present disclosure relates to a network node. The network node comprises:
a communication unit, configured to transmit, to a wireless device, time synchronization subscription information associated with a time synchronization service for a wireless terminal.

Various embodiments may preferably implement the following feature:

Preferably, the network node further comprises a processor configured to perform any of aforementioned wireless communication methods.

The present disclosure relates to a wireless terminal. The wireless terminal comprises:
a communication unit, configured to receive, from a wireless device, time synchronization subscription information associated with a time synchronization service for the wireless terminal.

Various embodiments may preferably implement the following feature:

Preferably, the wireless terminal further comprises a processor configured to perform any of aforementioned wireless communication methods.

The present disclosure relates to a computer program product comprising a computer-readable program medium code stored thereupon, the code, when executed by a processor, causing the processor to implement a wireless communication method recited in any one of the foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a network according to an embodiment of the present disclosure.

FIG. 2 shows a schematic diagram of a time synchronization according to an embodiment of the present disclosure.

FIG. 3 shows a schematic diagram of a time synchronization according to an embodiment of the present disclosure.

FIGS. 4 to 7 shows schematic diagrams of procedures according to embodiments of the present disclosure.

FIG. 8 shows an example of a schematic diagram of a wireless terminal according to an embodiment of the present disclosure.

FIG. 9 shows an example of a schematic diagram of a wireless network node according to an embodiment of the present disclosure.

FIGS. 10 to 12 show flowcharts of methods according to embodiments of the present disclosure.

### DETAILED DESCRIPTION

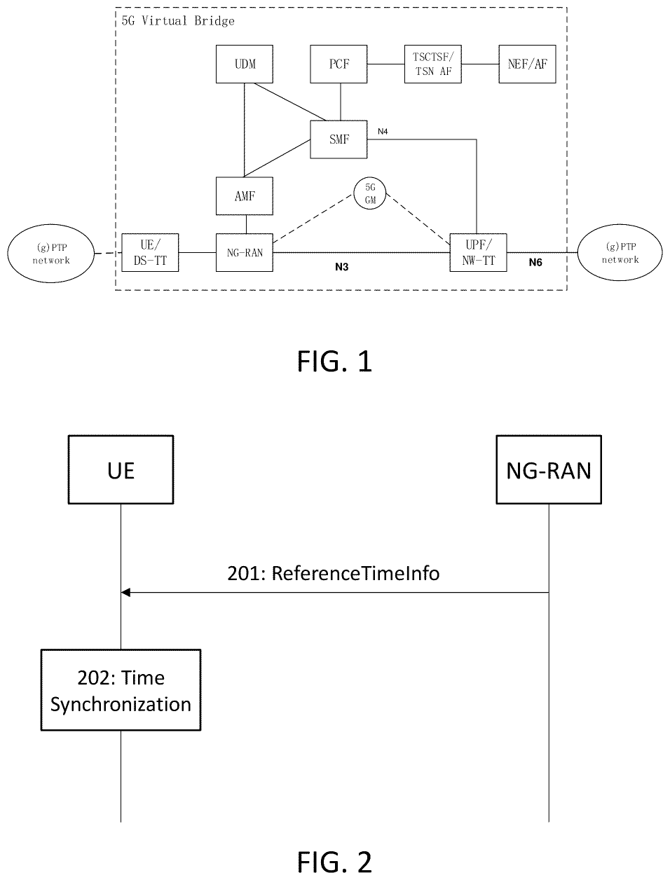

FIG. 1 shows a schematic diagram of a network (architecture) according to an embodiment of the present disclosure. In FIG. 1, the network comprises the following network functions/entities:

### 1) User Equipment (UE)

The UE accesses the 5GS and obtains services via the NG-RAN and interacts with an Access and Mobility Control Function (AMF) of the core network via the NAS signaling. The Device side TSN translator (DS-TT) is inside the UE and provides a (g)PTP port functionality for the time synchronization.

### 2) Next Generation Radio Access Network (NG-RAN)

The NG-RAN may also be called 5G-AN (5G Access network, i.e., 5G Radio Access Network). The NG-RAN is responsible for an air interface resource scheduling and an air interface connection management of the network to which the UE is accessed. In the present disclosure, the NG-RAN may be equal to NG-RAN node or RAN (node).

### 3) Access and Mobility Management Function (AMF)

The AMF includes the following functionalities: Registration management, Connection management, Reachability management and Mobility Management. This network function also performs an access authentication and an access authorization. The AMF is a non-access stratum (NAS) security termination and relays session management (SM) NAS among the UE and a session management function (SMF), . . . , etc.

### 4) Session Management Function (SMF)

The SMF includes the following functionalities: Session Management (e.g., Session establishment, modify and release), UE IP address allocation & management (including optional Authorization), Selection and control of UP function, downlink data notification, etc.

### 5) User Plane Function (UPF)

The UPF includes the following functionalities: Anchor point for Intra-/Inter-RAT mobility, Packet routing & forwarding, Traffic usage reporting, QoS handling for user plane, Downlink packet buffering and downlink data notification triggering, etc. The Network side TSN translator (DS-TT) is inside/comprised in the UPF and provides the (g)PTP port functionality for the time synchronization.

### 6) Policy Control Function (PCF)

The PCF includes the following functionality: Supports unified policy framework to govern network behavior, provides policy rules to Control Plane function(s) to enforce the policy rule, implements a Front End to access subscription information relevant for policy decisions in a User Data Repository (UDR).

### 7) Network Exposure Function (NEF)

The NEF is deployed optionally for exchanging information between 5GC (5G core network) and an external Application Function (AF). In the present disclosure, the NEF/AF is used to present the NEF and AF for brevity.

### 8) Time Sensitive Communication and Time Synchronization Function (TSCTSF)

The TSCTSF controls the time synchronization services by controlling the NG-RAN to enable the 5G Access stratum time distribution and configuring the DS-TT and NW-TT when the 5GS is not integrated with a TSN network.

### 9) Time Sensitive Network Adaptation Function (TSN AF)

The TSN AF provides interworking and adaptation with Centralized Network Configuration (CNC) in an external TSN network.

To support PTP based time synchronization services, the 5GS simulates/acts as a bridge to an external PTP network (e.g., a TSN network, or a network supporting a standard IEEE 1588). This TSN bridge is called virtual/logical bridge. The “logical” TSN Bridge includes TSN Translator (TT) functionalities (i.e., the DS-TT in the UE and the NW-TT in the UPF) for interoperation between the PTP network and the 5GS.

In the present disclosure, the PTP may be equal to gPTP (i.e., IEEE 8201.AS) since the PTP may be compatible with the gPTP.

In the present disclosure, the term GM may be equal to “GM clock”.

In FIG. 1, the network (architecture) comprises a 5G internal GM clock which is used as a time source (e.g., GPS clock or GM clock) in the network. The NG-RAN and the UPF/NW-TT p perform a time synchronization with the 5G GM separately. In other words, the NG-RAN and the UPF are assumed to be synchronous.

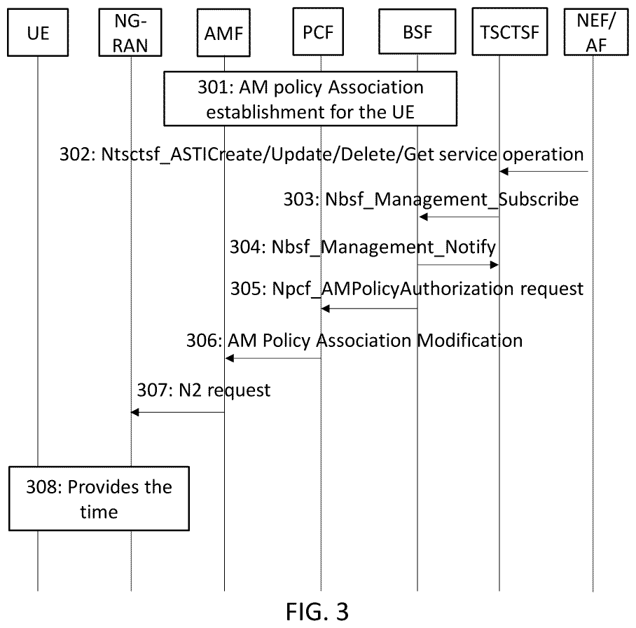

FIG. 2 shows schematic diagram of a time synchronization between the UE and the NG-RAN according to an embodiment of the present disclosure. Particularly, FIG. 2 shows how the UE obtains the 5G precise time over the air interface from the NG-RAN.

In step 201, the NG-RAN sends ReferenceTimeInfo to the UE in a SIB9 (System information Block 9) or RRC (radio resource control) message(s).

The ReferenceTimeInfo (i.e., reference time information) at least comprises the following information elements/fields:
referenceSFN: This field indicates a reference SFN (System Frame number) corresponding to a reference time and/or ReferenceTimeInfo.
Time (ReferenceTime): The time field indicates the (reference) time at a boundary (e.g., a start or an end) of the reference SFN.

In step 202, the UE synchronize with (the time in) the NG-RAN based on the received ReferenceTimeInfo.

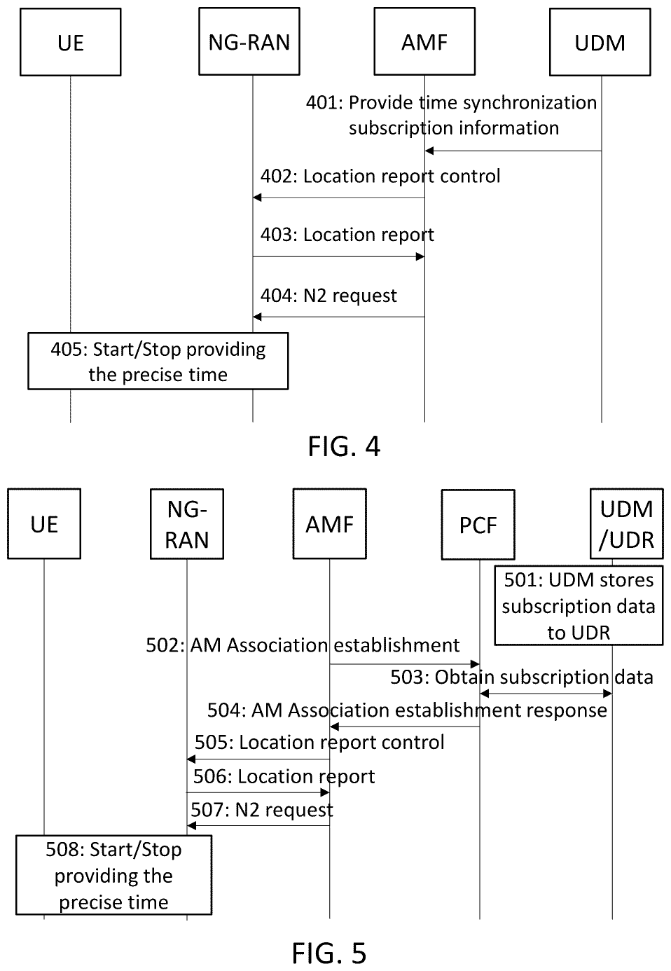

FIG. 3 shows a schematic diagram of a time synchronization procedure according to an embodiment of the present disclosure. In this embodiment, the UE synchronizes the time information via 5G access stratum time distribution on demand. Specifically, the procedure comprises the following steps:
Step 301: The AM Policy Association for the UE is established.
Step 302: The NEF/AF invokes the Ntsctsf_ASTICreate/Update/Delete/Get service operation with the TSCTSF.
Step 303: The TSCTSF searches the PCF for the UE using Nbsf_Management_Subscribe with UE ID (i.e., SUPI (SubscriptionPermanent Identifier)) as an input parameter, indicating that it is searching for the PCF that handles the AM Policy Association of the UE.
Step 304: The BSF provides to the TSCTSF the identity of the PCF for the UE for the requested SUPI via an Nbsf_Management_Notify operation. If matching entries already existed in the BSF when step 303 is performed, this shall be immediately reported to the TSCTSF.
Step 305. The TSCTSF sends to the PCF for the UE its request for the AM policy of the UE (identified by SUPI) using Npcf_AMPolicy Authorization request, containing the 5G access stratum time distribution indication.
Step 306: The PCF may initiate an AM Policy Association Modification procedure for the UE to provide AMF the 5G access stratum time distribution parameters.
Step 307: The AMF sends the 5G access stratum time distribution indication to an NG-RAN node using N2 request.
Step 308: The NG-RAN node provides the 5GS precise time to the UE via the AS (e.g., Step 201).

In an embodiment, the UE may subscribe the 5G access stratum time distribution service in a particular time synchronization service area. The UE may be restricted to obtain the time synchronization service only in this time synchronization service area. That is, when the UE moves out the time synchronization service area, the time synchronization service shall be stopped for the UE. Therefore, in an embodiment, the UE and/or related network function(s) may acquire information associated with the time synchronization subscription of the UE, so as to acknowledge whether the time synchronization service to the UE shall be stopped/started and perform corresponding operations.

In an embodiment, the UDM may store UE time synchronization subscription information, which may comprise a 5G access stratum time synchronization indication and/or related time synchronization area for the UE. Thus, the AMF may obtain the UE time synchronization subscription information which comprises the 5G access stratum time synchronization indication and related time synchronization service area via:
time synchronization subscription from the UDM, or
time synchronization policy date from the PCF.

In addition, the AMF may subscribe an Area of interesting for the UE from the NG-RAN.

As an alternative or in addition, the AMF may subscribe a UE Location reporting when the UE location is changed from the NG-RAN.

When the NG-RAN reports the notification of interesting area (e.g., UE in area or out of area) and/or the UE location, the AMF may send an N2 request to start or stop the time synchronization service for this UE.

In an embodiment, the UE may be provided with the time synchronization subscription information which comprises the 5G access stratum time synchronization indication and/or related time sync area. Under such a condition, when the UE moves out of the time synchronization area allowed for the UE, the UE acknowledges that the reference time information may not be acquired via the radio (air interface) because it moves out the allowed area and the UE can accordingly notify the application running on the UE.

The provision of the time synchronization subscription information to the UE may be implemented by:
The AMF provides the time synchronization subscription information in a NAS accept (message), or
The PCF/UDM provides the time synchronization subscription information in a transparent container.

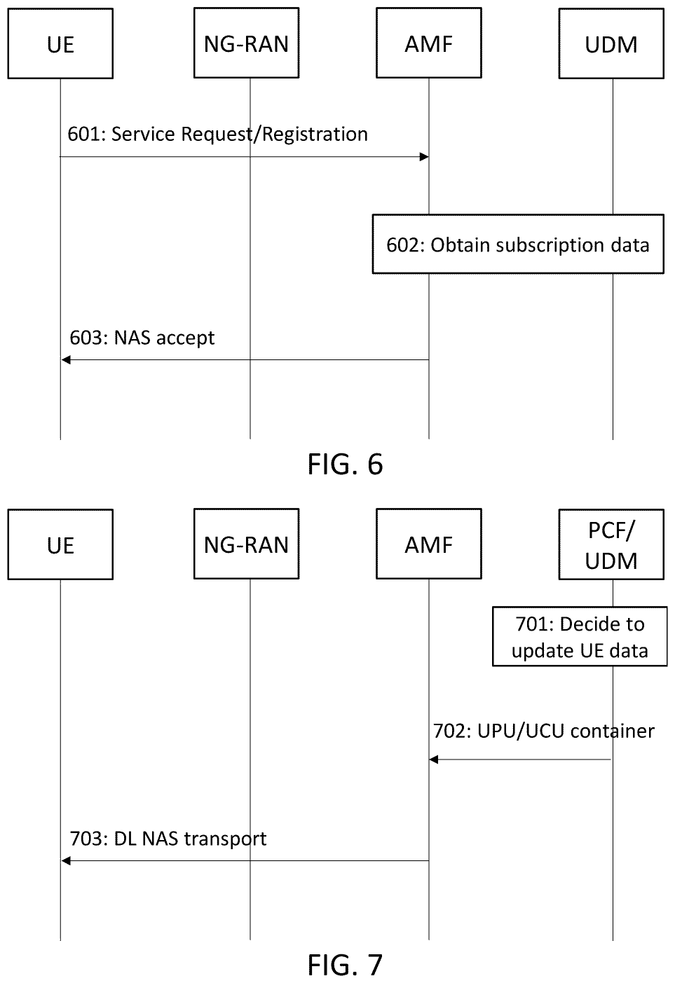

FIG. 4 shows a schematic diagram of a procedure according to an embodiment of the present disclosure. In FIG. 4, the UDM provides the time synchronization subscription information to the AMF. Based on time synchronization subscription information, the AMF controls the time synchronization service to the UE in the particular service area. In an embodiment, the time synchronization service area may include a tracking area identity (TAI) list and/or a cell list.
Step 401: The AMF is provided with the time synchronization subscription information by the UDM. The time synchronization subscription information includes the 5G access stratum time synchronization indication and/or related time sync area. This step can be in a UE registration procedure or User Profile management procedures. The UDM may use a Nudm_SDM_Get or Nudm_SDM_Notification service operation to provide the time synchronization subscription information to the AMF.
Step 402: The AMF sends a Location Reporting Control (e.g., comprising Reporting Type, Area Of Interest, location change) to the NG-RAN.
Step 403: The NG-RAN sends a Location Report message, to inform the AMF the location of the UE, e.g., the Presence of the UE in the Area Of Interest (i.e., IN, OUT, or UNKNOWN) and/or the UE location.
Step 404: According to whether the UE is in the time synchronization service area, the AMF sends the 5G access stratum time distribution indication to the NG-RAN to stop or start the time synchronization service/operation.
Step 405: According to the message from the AMF, the NG-RAN starts or stops providing the precise time to the UE.

FIG. 5 shows a schematic diagram of a procedure according to an embodiment of the present disclosure. In FIG. 5, the AMF uses UE policy data from PCF to control the time synchronization service to the UE in the particular service area. The PCF creates the policy data according to UE subscription data (i.e., time synchronization subscription information).
Step 501: The UDM store the UE subscription data to the UDR.
Step 502: The AMF requests to the PCF to provide policy rules for the UE. This step can be in a UE registration procedure and/or a Service request procedure. For example, the AMF may use Npcf_AMPolicyControl_Create/Update or Npcf_UEPolicyControl Create/Update service operation to request the policy rules from the PCF.
Step 503: The PCF obtains the UE subscription data from the UDR.
Step 504: The PCF creates the UE policy data according to the subscription data, which contain the 5G access stratum time synchronization indication and/or related time sync area. The PCF sends the UE policy data to AMF.
Step 505: The AMF sends a Location Reporting Control (e.g., comprising Reporting Type, Area Of Interest, location change) to the NG-RAN.
Step 506: The NG-RAN sends a Location Report message, to inform the AMF the location of the UE, e.g., the UE Presence in the Area Of Interest (i.e., IN, OUT, or UNKNOWN), or UE location.
Step 507: According to whether the UE is in the time synchronization service area, the AMF sends the 5G access stratum time distribution indication to the NG-RAN, to stop or start the time sync service/operation.
Step 508: According to the message from AMF, the NG-RAN starts or stops providing precise time to the UE.

FIG. 6 shows a schematic diagram of a procedure according to an embodiment of the present disclosure. In FIG. 6, the AMF provides the time synchronization subscription information to the UE. Therefore, when the UE moves out of the time synchronization service area allowed for the UE, the UE is able to acknowledge that reference time information may not be acquired form the radio (air interface) and the UE can accordingly notify the application running on the UE.
Step 601: The UE send a NAS (Non-Access Stratum) message (e.g., Service request, Registration) to AMF via the NG-RAN.
Step 602: The AMF obtains UE time synchronization subscription information from the UDM or PCF (see, e.g., FIG. 4 or 5). The UE time synchronization subscription information may comprise the 5G access stratum time synchronization indication and/or related time synchronization service area.
Step 603: The AMF send the NAS Accept message (e.g., service request accept, registration accept) which comprises the UE time synchronization subscription information to the UE via the NG-RAN.

FIG. 7 shows a schematic diagram of a procedure according to an embodiment of the present disclosure. In FIG. 7, the UE is provided with the time synchronization information by the PCF/UDM.
Step 701: The UDM or PCF determines to update the UE data about the time synchronization subscription information. The PCF acquires the UE time synchronization subscription information from UDR (see, e.g., step 503 in FIG. 5). The UE time synchronization subscription information may comprise the 5G access stratum time synchronization indication and/or related time synchronization service area.
Step 702: The PCF/UDM sends the updated data container. If the PCF determines the update, the PCF invokes Namf_Communication_N1N2MessageTransfer service operation to the AMF with a UE Policy Container. If the UDM determine the update, the UDM invokes Nudm_SDM_Notification service operation to the AMF with UE parameters update transparent container. Each of these containers comprises the UE time synchronization subscription information.
Step 703: The AMF transparently transfers the transparent container received from the PCF or the UDM to the UE. The UE time synchronization subscription information is comprised in the transparent container.

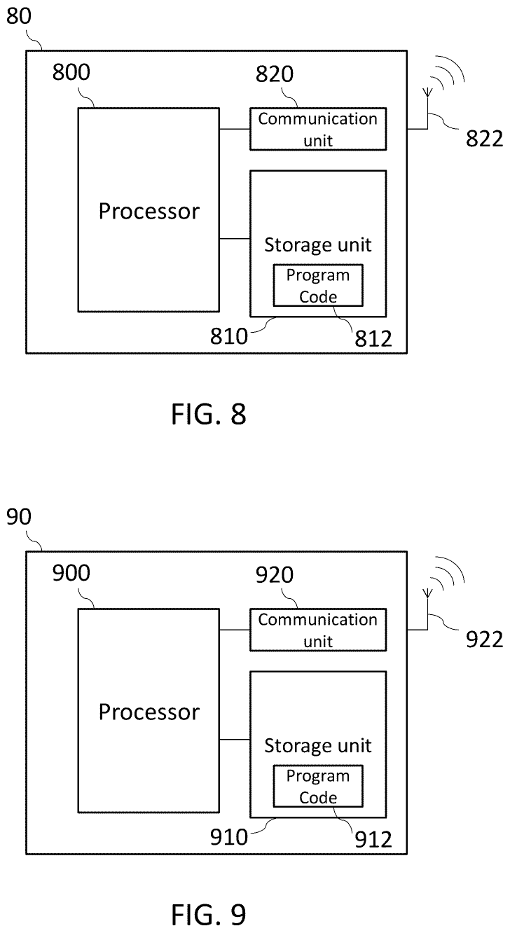

FIG. 8 relates to a schematic diagram of a wireless terminal 80 according to an embodiment of the present disclosure. The wireless terminal 80 may be a user equipment (UE), a mobile phone, a laptop, a tablet computer, an electronic book or a portable computer system and is not limited herein. The wireless terminal 80 may include a processor 800 such as a microprocessor or Application Specific Integrated Circuit (ASIC), a storage unit 810 and a communication unit 820. The storage unit 810 may be any data storage device that stores a program code 812, which is accessed and executed by the processor 800. Embodiments of the storage unit 810 include but are not limited to a subscriber identity module (SIM), read-only memory (ROM), flash memory, random-access memory (RAM), hard-disk, and optical data storage device. The communication unit 820 may a transceiver and is used to transmit and receive signals (e.g., messages or packets) according to processing results of the processor 800. In an embodiment, the communication unit 820 transmits and receives the signals via at least one antenna 822 shown in FIG. 8.

In an embodiment, the storage unit 810 and the program code 812 may be omitted and the processor 800 may include a storage unit with stored program code.

The processor 800 may implement any one of the steps in exemplified embodiments on the wireless terminal 80, e.g., by executing the program code 812.

The communication unit 820 may be a transceiver. The communication unit 820 may as an alternative or in addition be combining a transmitting unit and a receiving unit configured to transmit and to receive, respectively, signals to and from a wireless network node (e.g., a base station).

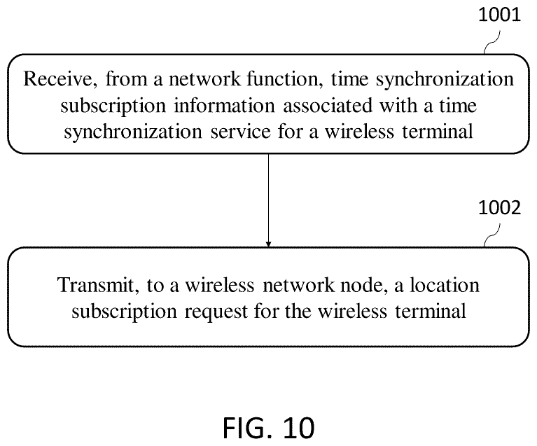

FIG. 9 relates to a schematic diagram of a wireless network node 90 according to an embodiment of the present disclosure. The wireless network node 90 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 90 may comprise (perform) at least one network function such as an access and mobility management function (AMF), a session management function (SMF), a user place function (UPF), a policy control function (PCF), an application function (AF), etc. The wireless network node 90 may include a processor 900 such as a microprocessor or ASIC, a storage unit 910 and a communication unit 920. The storage unit 910 may be any data storage device that stores a program code 912, which is accessed and executed by the processor 900. Examples of the storage unit 910 include but are not limited to a SIM, ROM, flash memory, RAM, hard-disk, and optical data storage device. The communication unit 920 may be a transceiver and is used to transmit and receive signals (e.g., messages or packets) according to processing results of the processor 900. In an example, the communication unit 920 transmits and receives the signals via at least one antenna 922 shown in FIG. 9.

In an embodiment, the storage unit 910 and the program code 912 may be omitted. The processor 900 may include a storage unit with stored program code.

The processor 900 may implement any steps described in exemplified embodiments on the wireless network node 90, e.g., via executing the program code 912.

The communication unit 920 may be a transceiver. The communication unit 920 may as an alternative or in addition be combining a transmitting unit and a receiving unit configured to transmit and to receive, respectively, signals to and from a wireless terminal (e.g., a user equipment or another wireless network node).

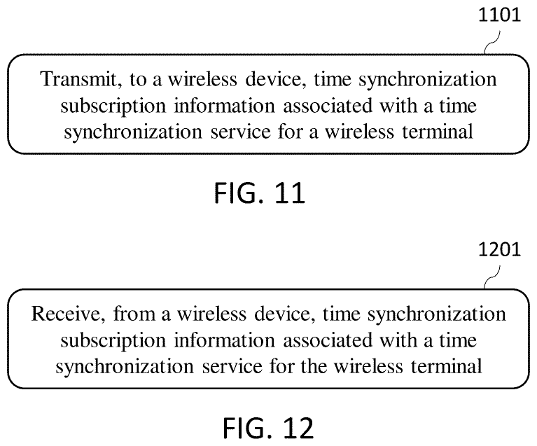

FIG. 10 shows a flowchart of a method according to an embodiment of the present disclosure. The method shown in FIG. 10 may be used in an AMF (e.g., an access and mobility management node, a wireless device comprising the AMF or a wireless device performing at least part of functionalities of the AMF) and comprises the following steps:
Step 1001: Receive, from a network function, time synchronization subscription information associated with a time synchronization service for a wireless terminal.
Step 1002: Transmit, to a wireless network node, a location subscription request for the wireless terminal.

In FIG. 10, the AMF receives time synchronization subscription information associated with a time synchronization service for a wireless terminal (e.g., UE) from a network function (e.g., PCF or UDM). The AMF further transmits a location subscription request for the wireless terminal to a wireless network node (e.g., BS, gNB or RAN node). Under such conditions, the AMF is able to provide the time synchronization service to the UE in a particular area.

In an embodiment, the time synchronization subscription information comprises a time synchronization indication associated with a time synchronization subscription (for/towards/associated with the time synchronization service) of the wireless terminal and/or a time synchronization service area associated with providing the time synchronization service to the wireless terminal.

In an embodiment, the location subscription request is for subscribing to a notification associated with the wireless terminal being in or out of a time synchronization area or a notification associated with a location of the wireless terminal.

In an embodiment, the AMF receives a notification in response to the location subscription request. For instance, the notification may indicate a location of the wireless terminal or that the wireless terminal is in or out of the time synchronization area. Based on the received notification, the AMF transmits a request associated with providing the time synchronization service to the wireless terminal. For example, the AMF may determine, based on the notification. that the wireless terminal is in the time synchronization area. In this example, the request transmitted from the AMF to the wireless network node is for initiating/starting providing the time synchronization service to the wireless terminal. In another example, the AMF may determine, based on the notification. that the wireless terminal is out of the time synchronization area. Under such a condition, the AMF transmits the request to the wireless network node to stop providing the time synchronization service to the wireless terminal.

In an embodiment, the AMF may provide the time synchronization subscription information to the wireless terminal. For example, the AMF may receive a request associated with the time synchronization subscription information from the wireless terminal and transmits the the time synchronization subscription information in response. In an embodiment, the request associated with the time synchronization subscription information may be a service request or a service registration (request).

FIG. 11 shows a flowchart of a method according to an embodiment of the present disclosure. The method shown in FIG. 11 may be used in a network function (e.g., a network node, a network node comprising the PCF and/or UDM, or a network node performing at least part of functionalities of the PCF and/or UDM) and comprises the following step:
Step 1101: Transmitting, to a wireless device, time synchronization subscription information associated with a time synchronization service for a wireless terminal.

In this embodiment, the network function transmits time synchronization subscription information associated with a time synchronization service for a wireless terminal (e.g., UE) to a wireless device. The wireless device may be the wireless terminal and/or a wireless network node (e.g. BS, gNB, RAN node).

In an embodiment, the time synchronization subscription information comprises a time synchronization indication associated with a time synchronization subscription (for/towards/associated with the time synchronization service) of the wireless terminal and/or a time synchronization service area associated with providing the time synchronization service to the wireless terminal.

Note that the messages/operations used for transmitting the time synchronization subscription information can be referred to the aforementioned embodiments.

FIG. 12 shows a flowchart of a method according to an embodiment of the present disclosure. The method shown in FIG. 12 may be used in a wireless terminal (e.g., UE) and comprises the following step:
Step 1201: Receive, from a wireless device, time synchronization subscription information associated with a time synchronization service for the wireless terminal.

In FIG. 12, the wireless terminal receives time synchronization subscription information associated with a time synchronization service for the wireless terminal. Based on the received time synchronization subscription information, the UE therefore can determine whether the time synchronization service is provided or not.

In an embodiment, in an embodiment, the time synchronization subscription information comprises a time synchronization indication associated with a time synchronization subscription (for/towards/associated with the time synchronization service) of the wireless terminal and/or a time synchronization service area associated with providing the time synchronization service to the wireless terminal.

In an embodiment, the wireless device comprises/is an AMF. In this embodiment, the wireless terminal may further transmit a request associated with the time synchronization subscription information to the wireless device, e.g., a service request or a service registration.

In an embodiment, the wireless device comprises/is a UDM and/or a PCF. In this embodiment, the wireless terminal receives the time synchronization subscription information from the wireless device via an AMF (see, e.g., FIG. 7).

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in an access and mobility management function, the method comprising:
receiving, from a network function, time synchronization subscription information associated with a time synchronization service for a wireless terminal, and
transmitting, to a wireless network node, a location subscription request for the wireless terminal.

2. The wireless communication method of claim 1, wherein the time synchronization subscription information comprises at least one of:
a time synchronization indication associated with a time synchronization subscription of the wireless terminal, or
a time synchronization service area associated with providing the time synchronization service to the wireless terminal.

3. The wireless communication method of claim 1, wherein the location subscription request is for subscribing to a notification associated with the wireless terminal being in or out of a time synchronization area or a notification associated with a location of the wireless terminal.

4. The wireless communication method of claim 1, further comprising:
receiving, from the wireless network node, a notification in response to the location subscription request,
transmitting, to the wireless network node, a request associated with providing the time synchronization service to the wireless terminal.

5. The wireless communication method of claim 4, wherein the wireless terminal is in a time synchronization area based on the notification, and
wherein the request indicates initiating providing the time synchronization service to the wireless terminal.

6. The wireless communication method of claim 4, wherein the wireless terminal is out of a time synchronization area based on the notification, and
wherein the request indicates stopping providing the time synchronization service to the wireless terminal.

7. The wireless communication method of claim 1, further comprising:
transmitting, to the wireless terminal, the time synchronization subscription information.

8. The wireless communication method of claim 7, further comprising:
receiving, from the wireless terminal, a request associated with the time synchronization subscription information.

9. The wireless communication method of claim 1, wherein the network function comprises at least one of a unified data management or a policy control function.

10. A wireless communication method for use in a network function, the method comprising:
transmitting, to a wireless device, time synchronization subscription information associated with a time synchronization service for a wireless terminal.

11. The wireless communication method of claim 10, wherein the time synchronization subscription information comprises at least one of:
a time synchronization indication associated with a time synchronization subscription of the wireless terminal, or
a time synchronization service area associated with providing a time synchronization service to the wireless terminal.

12. The wireless communication method of claim 10, wherein the network function comprises at least one of a unified data management or a policy control function.

13. The wireless communication method of claim 10, wherein the wireless device is the wireless terminal or an access and mobility management function.

14. A wireless communication method for use in a wireless terminal, the method comprising:
receiving, from a wireless device, time synchronization subscription information associated with a time synchronization service for the wireless terminal.

15. The wireless communication method of claim 14, wherein the time synchronization subscription information comprises at least one of:
a time synchronization indication associated with a time synchronization subscription of the wireless terminal, or
a time synchronization service area associated with providing a time synchronization service to the wireless terminal.

16. The wireless communication method of claim 14, wherein the wireless device comprises an access and mobility management function.

17. The wireless communication method of claim 16, further comprising:
transmitting, to the wireless device, a request associated with the time synchronization subscription information.

18. The wireless communication method of claim 14, wherein the wireless device comprises at least one of a unified data management or a policy control function.

19. The wireless communication method of claim 18, wherein the wireless terminal receives the time synchronization subscription information from the wireless device via an access and mobility management function.

20. A non-transitory computer readable medium having code stored thereupon, wherein the code, when executed by a processor, causes the processor to implement the wireless communication method according to claim 1.
